(19) United States
(12) Patent Application Publication
(10) Pub. No.: US 2002/0127158 A1
(43) Pub. Date: Sep. 12, 2002

(54) Portable water ozonator and air/water supply control unit

(75) Inventors: Ralph L. Holsclaw, Louisville, KY (US); Ray S. Ellis JR., New Albany, IN (US)

Correspondence Address: David W. Carrithers, CARRITHERS LAW OFFICE, One Paragon Centre, 6060 Dutchman's Lane, Suite 140, Louisville, KY, 40205, US

(73) Assignee: MARCO EQUIPMENT DISTRIBUTORS, INC.

(21) Appl. No.: 10/126,056

(22) Filed: Apr. 19, 2002

Related U.S. Application Data
(63) Continuation-in-part of application No. 09/771,749, filed on Jan. 29, 2001.

(51) Int. Cl. B01J 19/08; B01J 19/12

(52) U.S. Cl. 422/186.07

(57) ABSTRACT

A portable unit that produces ozonated water cleaning water lines to water dependent dental devices and appliances. The ozonated water disinfects/sterilizes and cleans quickly and without leaving any residue because the ozone quickly converts to oxygen and goes into the atmosphere. Thus, little or no rinsing is required after using the ozonated water to clean a machine or device. More particularly the apparatus is a portable unit generates ozone and injects into water flowing to the dental/medical/veterinary appliance(s) during use of the same. The freshly ozonated water produced purifies the lines and instruments. Excess ozonated water produced is diverted to a drain and maybe collected for later use as a disinfectant/sterilization in other dental/medical applications, operations, and procedures.

This application claims priority from pending U.S. application Ser. No. 09/771,749 filed on Jan. 29, 2001 and is hereby incorporated by reference.

### FIELD OF INVENTION

The present invention relates generally to the disinfection/sterilization of dental water lines and the removal of biofilm therefrom and more particularly to a portable unit in which ozonated water is produced when desired during use of the water dependent dental apparatus and procedures.

### BACKGROUND OF INVENTION

Tap water in dental offices is similar to drinking water in most public facilities. Although the water is generally considered safe to drink it is not sterile, but contains at least some bacteria counted by CFU/ml, (colony forming units per millilters). The water is transferred to the dental offertories through metal or plastic tubing and is supplied to dental handpieces and other dental implements, such as air-water syringes and ultrasonic tooth scalers. Because the water is used at a low flow rate, at infrequent intervals the internal surfaces of the supply lines are ideal for microbial contamination.

As reported by the National Center for the Chronic Disease Prevention and Health Promotion, of the Center for Disease Control, (CDC), and set forth in the report published on the Internet under the heading of ‘Waterborne Infection Control’ on Jan. 24, 2001, the problem with water with the quality of the water used in dental applications was reported more than 30 years ago. The reports states that levels of microbial contamination as high as 10,000 to 10,000,000 CFUs/m.l. have been documented wherein the standard established by the Federal Safe Water Drinking Act for potable water is around 500 CFUs/m.l. of noncoliform bacterial.

Moreover, water that stagnates in plastic water lines and/or tubing overnight and even during long periods during the day provide bacteria the opportunity to stick to the wall of the lines/tubing. Microbial biofilm tends to form along the walls of the long, narow-bore tubing that is used to provide for cooling and irrigating water for dental hand instruments. As set forth in the aforesaid CDC report, microbial biofilm are formed by microorganisms, including bacteria, fungi, and protozoans, that colonize and replicate on the interior surfaces of the waterline tubing formaing a protective slime layer known as a biofilm. Due to the small diameter of the lines, the surface to volume ratio provides an excellent environment for bacterial growth. Moreover, the slow laminar flow rate of the water there through creates an area of laminar flow near the sidewalls of the tubing with very slow flow rates creating stagnant conditions.

The CDC report established that the primary source of the microorganisms is the public water supply. The American Dental Association, (ADA), has developed a statement on dental unit water lines acknowledging the existence of dental unit water that may be of poor microbiologic quality and has established a goal of limiting the delivery of water to dental patients during nonsurgical procedures of 200 CFUs/m or less. The panels also set forth recommended strategies of prevention including devices to monitor water quality, and separate water reservoirs independent of the public water supply, purging water supplies, and inline filters. However, the report goes on to state that none of the methods known appears to permanently eradicate biofilms.

Most dental unit water lines harbor biofilms that continually shed planktonic organisms as the water is utilized. Many different approaches are being studied to control microbial contamination. Ozone applications to dental unit water line disinfection has been limited. The major drawback appears to be the relative short half-life of ozone, which results in a lack of residual ozone in the water following treatment.

In a prior proposed apparatus water is ozonated and provided for disinfecting water lines and a variety of dental instruments such as drills, syringes and an expectoration bowl. The apparatus included at least one water reservoir connected through fluid conduits with such instruments and an ozone producing device supplied ozonated water to the water reservoir. The ozone level in the reservoir or tank needed to be replenished with fresh ozonated water periodically, usually every 24 hours. The freshly ozonated water purifies the lines and instruments and the remainder of the ozonated water remained in the reservoir for use throughout the day for dental applications and with dental instruments.

### SUMMARY OF INVENTION

A principal object of the present invention is to provide a compact simple portable unit that produces ozonated water during dental procedures to destroy microbes present in a dental water line and/or the water itself each time water flows through the line to a water dependent dental hand piece or implement. A portion of the ozonated water produced from the operation of the unit is bleed off to be used to disinfect instruments or tubing while the main stream of ozonated water is discarded into the sewer; however it is anticipated that for some applications the entire stream of ozonated water could be used in the disinfection/sterilization process or the excess ozonated water stream could be diverted to a temporary holding tank or used in some other disinfection/sterilization application or as a source of feed water or portable water which could be very important in arid environments. Although the ozone in the water starts to dissipate immediately after treatment the deozonation process continues for up to at least thirty minutes providing a reservoir of treated water.

In accordance with the present invention, an ozone generator provides an outflow of ozone enriched air that is introduced to water flowing through a venturi or the like to entrain the ozone enriched air into the water. The ozonated water produced by the present invention can be used immediately while the dentist is utilizing the water dependent implements and instruments during the normal course of providing dental services or used after in a single cleaning cycle by circulating the ozonated water through the lines and/or instruments/tools for a selected period of time to disinfect same. The ozone introduced into the water will destroy any microbial pathogens in the water and render it essentially microbe free. Furthermore, the living organisms in any biofilm attendant the walls of the water lines will be destroyed upon contact with the ozone. Thus, the water delivered to a patient's oral cavity during the rendering of dental services will be essentially free of any viable microbial activity.

More particularly, the instant portable unit for producing and controllably directing ozonated water to disinfect an item such as a dependent dental/medical appliance/tool includes an ozone generator having a fluid flow path therethrough that commences at an air inlet means thereon that is connectable to a pressurized air supply such as that of a compressor and terminates in an ozonated air outlet means. A means for connecting the ozone generator to a suitable electrical power source is provided for producing ozone from oxygen in the air as the air flows through the generator. A venturi injector having a first and a second inlet means and an outlet means in connected to a first conduit means providing a fluid flow path from the ozonated air outlet means of the ozone generator to one of the first and second inlet means of the venturi injector. The unit includes a solenoid operated valve in the first conduit means for controlling the flow of ozonated air through the conduit to the venturi injector. A second conduit means connected to the other one of the first and second inlet means of the venturi injector is adapted to be connected to a pressurized water supply. A second solenoid operated valve in the second conduit means for controlling the flow of water therethrough to the venturi injector is included together with a third conduit means connected to the outlet means of the venturi injector adapted to be connected to at least one water dependent appliance. A circuit means connected to the ozone generator and solenoid actuated valves provide flow of ozonated water to the third conduit.

### BRIEF DESCRIPTION OF THE DRAWINGS

A better understanding of the present invention, illustrated by way of example in the accompanying drawings, will be had upon reference to the following description in conjunction with the accompanying drawings in which like numerals refer to like parts throughout the several views and wherein:

FIG. 1 is an exploded oblique view of a portable unit provided in accordance with the present invention that produces ozonated water for use in dental applications;

FIG. 2 is an oblique view of the unit, shown in FIG. 1, in an assembled state;

FIG. 3 is a front elevational view of the unit shown in FIG. 2;

FIG. 4 is a rear elevational view of the unit shown in FIG. 2;

FIG. 5 is an electrical schematic for the apparatus in the unit shown in FIG. 1; and

FIG. 6 is a schematic of the air and water flow control system for the unit shown in FIG. 2.

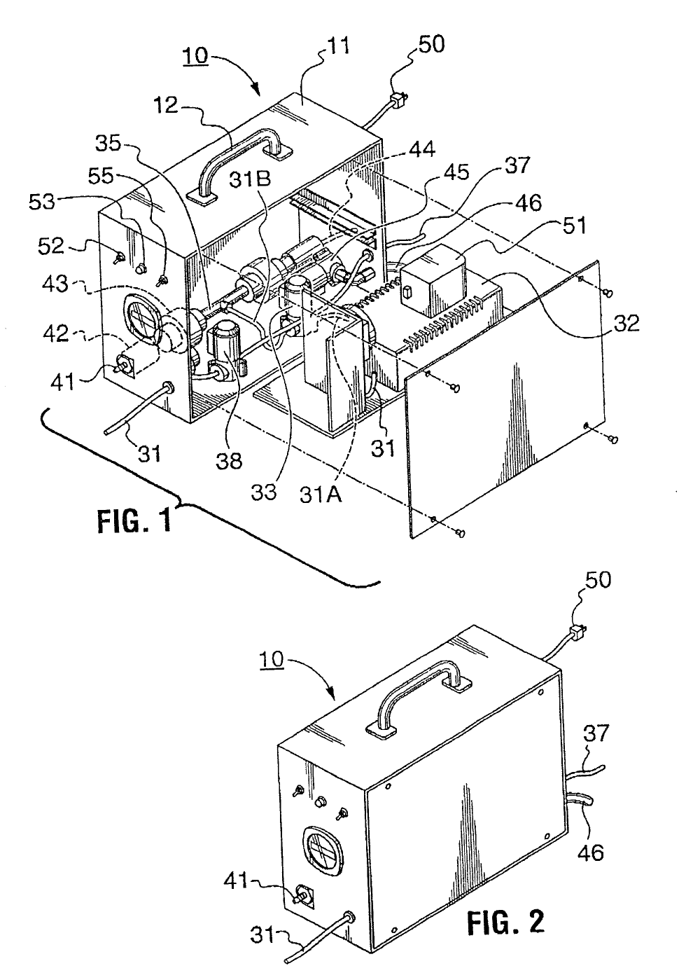

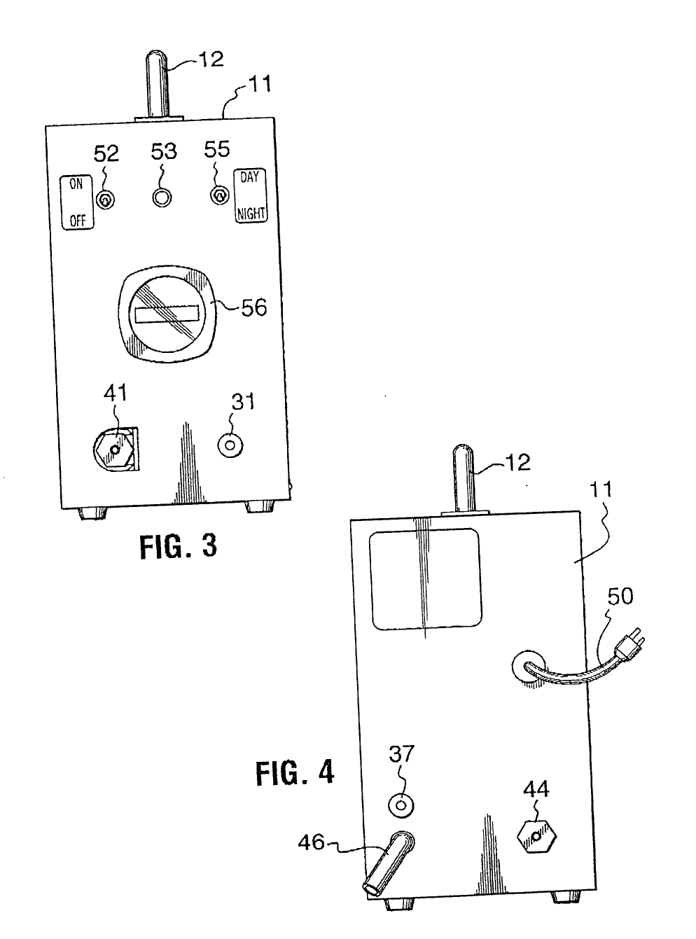

### DETAILED DESCRIPTION OF THE PREFERRED EMBODIMENTS

Referring to the drawings there is illustrated a portable unit 10 for producing ozonated water and controllably directing air and the ozonated water to dental appliances. The ozonated water is produced by the apparatus within the unit during use and thus ozonated water is generated as desired at the time of use of the instrument.

The portable unit 10 includes a housing 11 having a carrying handle 12 attached thereto and a power cord 50 extending the housing for plugging into an electrical power outlet. Located in the housing is a cold spark corona discharge ozone generator 32 having an air inlet side that connects to a pressurized air supply by an air inlet conduit 31 and an ozone air outlet side that is connected to a venturi injector 35 by conduits 31A, 31B that are connected and separated one from the other by a solenoid actuated valve 33. Flow of ozonated air through the conduit is controlled by the solenoid operated valve 33. A one way flow control valve 34, which maybe a separate valve or incorporated in the solenoid controlled valve or incorporated in the venturi injector 31, prevents back flow to the ozone generator.

The air inlet conduit 31 is connected to an air outlet conduit 37 through a solenoid actuated valve 38 to provide controlled air flow to the various air operated dental tools that are to be used.

The ozone generator 32 converts oxygen in the air into ozone by passing an electric arc through the air in a known process. The air supplied to the ozone generator can be conditioned by passing it through a suitable filter and/or dehumidifier. If desired a rheostat may be provided to control the rate of production of ozone.

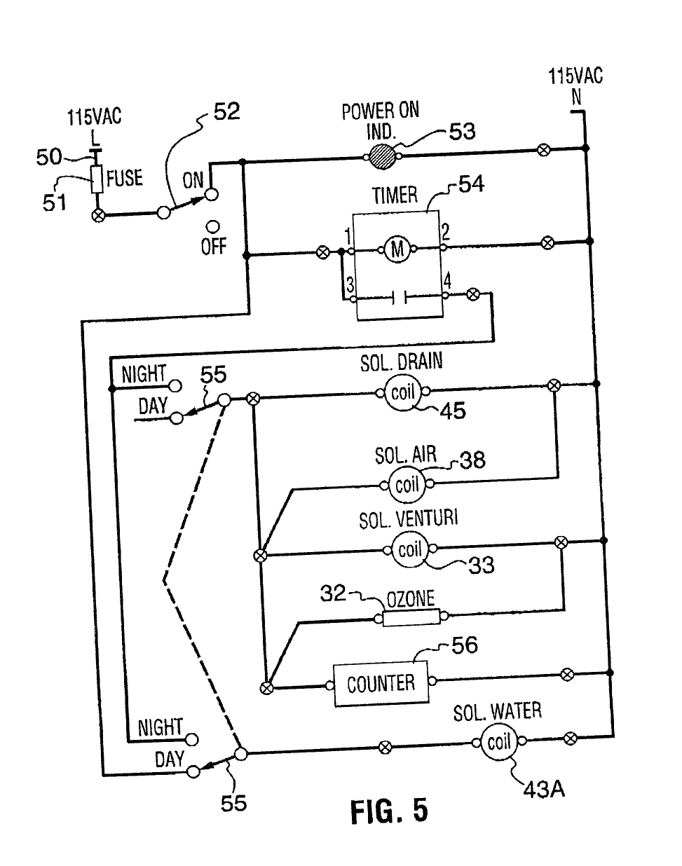

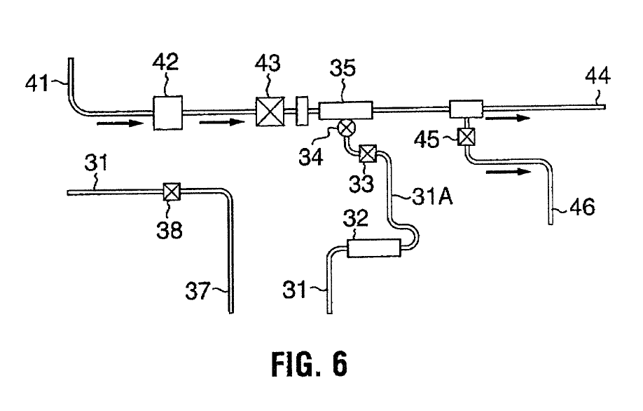

The ozone generator connects to a converter 51 that provides DC power from the AC power obtained by plugging the power cord into an office power outlet receptacle. The circuit for the unit (see FIG. 5) includes a power on/off switch 52, a power on indicator light 53 and a double pole day/night switch 55.

The unit 10 connects to a pressurized water supply, such as a municipal water distribution outlet, by way of a water supply inlet coupling 41. The water pressure maybe that of the municipal system or, if desired, a pressure regulator 42 may be provided in the supply line to provide a pressure as may be desired for the system. From the inlet 41 water flow, through a conduit to the venturi injector 35, is controlled by a water supply solenoid operated valve 43. Ozonated water is provided to one or more dental appliances that connect, via suitable means, to an ozonated water outlet conduit 44. Excess ozonated water is diverted to a drain, or suitable collector, by a solenoid actuated valve 45, through a drain conduit 46.

The apparatus produces ozonated water that is controllably directed to the dental appliances during use of the same and thus the water lines thereto are kept clean. The unit for example may have a capacity of producing 360 milliliters/min and a flow rate of up to 3 liters/min with 60 milliliters/min available to each of a plurality of dental/medical appliances/tools.

With the switch 55 in the day position i.e. for the unit to clean solenoid valve 43 opens, the drain by-pass solenoid valve 45 is energized, the ozone generator solenoid valve is 33 energized, the ozone generator is energized and the air solenoid valve is energized. After a complete clean cycle the solenoid valves 33, 45, 43 and the ozone generator are de-energized.

It is also contemplated that the present invention provide a portable ozone generation device for use in veterinary clinics or mobile care units, hospitals or the like such as may be used by the military in MASH units to disinfect tools and the like.

The foregoing detailed description is given primarily for clearness of understanding and no unnecessary limitations are to be understood therefrom, for modifications will become obvious to those skilled in the art based upon more recent disclosures and may be made without departing from the spirit of the invention and scope of the appended claims.

We claim:

1. A portable unit for producing and controllably directing ozonated water to at least one water dependent dental appliance comprising:
(a) an ozone generator having a fluid flow path there through that commences at an air inlet means thereon that is connectable to a pressurized air supply and terminates in an ozonated air outlet means, means for connecting said ozone generator to a suitable electrical power source for producing ozone from oxygen in the air as the air flows through the generator;
(b) a venturi injector having a first and a second inlet means and an outlet means;
(c) a first conduit means providing a fluid flow path from said ozonated air outlet means of said ozone generator to one of said first and second inlet means of said venturi injector, a solenoid operated valve in said first conduit means for controlling the flow of ozonated air through the conduit to said venturi injector;
(d) a second conduit means connected to the other one of said first and second inlet means of said venturi injector and adapted to be connected to a pressurized water supply, a second solenoid operated valve in said second conduit means for controlling the flow of water there through to said venturi injector;
(e) third conduit means connected to said outlet means of said venturi injector and adapted to be connected to at least one water dependent dental appliance; and
(g) circuit means connected to said ozone generator and solenoid actuated valves to provide flow of ozonated water to said third conduit.

2. The portable unit as defined in claim 1, including a by-pass conduit means connected to said third conduit means and a third solenoid operated valve in said by-pass conduit means for controlling the flow there through of excess ozonated water.

3. The portable unit as defined in claim 2 including a water pressure regulator in the fluid flow path through said second conduit means.

4. A portable unit for producing ozonated water for use at least one water dependent dental appliance comprising:
(a) a housing
(b) an ozone generator located in said housing, said ozone generator having a fluid flow path there through commencing at an air inlet means thereto and terminating in an ozonated air outlet means, an air supply inlet coupling means mounted on said housing and connected by suitable conduit means to said ozone generator air inlet means, means for connecting said ozone generator to a suitable electrical power source for producing ozone from oxygen in the air as the air flows through the generator;
(c) a venturi injector having a first and a second inlet means and an outlet means;
(d) a first conduit means connected to said ozonated air outlet means and providing a fluid flow path therefrom to one of said first and second inlet means of said venturi injector, a solenoid operated valve in said first conduit means for controlling the flow of ozonated air there through to said venturi injector;
(e) a second conduit means connected to the other one of said first and second inlet means of said venturi injector and adapted to be connected to a pressurized water supply, a second solenoid operated valve in said second conduit means for controlling the flow of water there through to said venturi injector;
(f) third conduit means connected to said outlet means of said venturi injector and adapted to be connected to at least one water dependent dental appliance; and
(g) circuit means connected to said ozone generator and solenoid actuated valves to provide flow of ozonated water to said third conduit.

5. A portable unit for producing ozonated water for producing disinfected water, comprising:
(a) a housing
(b) an ozone generator located in said housing, said ozone generator having a fluid flow path there through commencing at an air inlet means thereto and terminating in an ozonated air outlet means, an air supply inlet coupling means mounted on said housing and connected by suitable conduit means to said ozone generator air inlet means, means for connecting said ozone generator to a suitable electrical power source for producing ozone from oxygen in the air as the air flows through the generator;
(c) a venturi injector having a first and a second inlet means and an outlet means;
(d) a first conduit means connected to said ozonated air outlet means and providing a fluid flow path therefrom to one of said first and second inlet means of said venturi injector, a solenoid operated valve in said first conduit means for controlling the flow of ozonated air there through to said venturi injector;
(e) a second conduit means connected to the other one of said first and second inlet means of said venturi injector and adapted to be connected to a pressurized water supply, a second solenoid operated valve in said second conduit means for controlling the flow of water there through to said venturi injector;
(f) third conduit means connected to said outlet means of said venturi injector and adapted to be connected to at least one device to be disinfected; and
(g) circuit means connected to said ozone generator and solenoid actuated valves to provide flow of ozonated water to said third conduit.
